(19) United States
(12) Patent Application Publication
(10) Pub. No.: US 2004/0107730 A1
(43) Pub. Date: Jun. 10, 2004

(54) Method and device for quality control and cut optimization of optical raw materials

(76) Inventors: Joachim Hengst, Gau-Algesheim (DE); Frank-Thomas Lentes, Bingen (DE); Christian Kusch, Jena (DE); Markus Vos, Ingelheim (DE)

Correspondence Address: STRIKER, STRIKER & STENBY, 103 East Neck Road, Huntington, NY, 11743, US

(21) Appl. No.: 10/379,645

(22) Filed: Mar. 5, 2003

(30) Foreign Application Priority Data
Mar. 5, 2002 (DE) 102 09 593.0

(51) Int. Cl. C03B 5/26

(52) U.S. Cl. 65/29.18

(57) ABSTRACT

A method for quality control of a body comprising an optical raw material and for optimizing its being cut apart into optical elements is described, in which optical discontinuities in the body are detected and the optical elements are cut from those body parts that have as few discontinuities as possible or are essentially free of discontinuities. The method is distinguished in that the three-dimensional shape of the body is detected by means of three-dimensional geometry recognition in a coordinate system, and the optical properties of the body are detected, in body planes located above the other and formed of pixels, by means of scanning radiation, and from that, a three-dimensional image of the optical properties of the body is generated. The optical elements obtained by the method are suitable for DUV lithography, among other purposes.

### SPECIFICATION

The invention relates to a method for quality control and cut optimization of optical raw materials, as well as to optical elements obtained with it.

Glass, in its manifold forms and variants, is one of the most widely used raw materials for optical purposes. For technical purposes, even large-volume glass bodies must as a rule meet a great number of demands, particularly with regard to purity, homogeneity, and freedom from defects, so that the transmission through the glass body is as free of distortion and attenuation as possible.

For optical components, increasingly crystals are used, particularly for wavelengths outside the visible range, for which glasses are no longer especially highly permeable. For instance, there is an increasing demand for monocrystalline material comprising alkali and alkaline earth fluorides (CaF₂, BaF₂, SrF₂, NaF, KF, CsF, and so forth) for UV applications, such as UV lithography/microlithography, and for lenses and flat parts (windows) and prisms for irradiation and imaging equipment, or even telescopes for astronomy, for instance. At the same time, crystals in the infrared spectral range form the basis for many optical elements.

Calcium fluoride monocrystals (CaF₂) are particularly needed as starting material for optical components in DUV photolithography (DUV stands for deep UV), at wavelengths around and below 200 nm, and particular for the wavelengths 248 nm, 193 nm and 157 nm of the excimer lasers used. The optical components are typically lenses and prisms in so-called steppers or excimer lasers and serve particularly, in the production of semiconductor circuits, for optically copying the fine circuit structures of the integrated circuits onto the masks used in the photolithography and/or onto the photoresist-coated semiconductor wafers.

CaF₂ crystals for use in projection optics for the UV and DUV range must first be free of the coarsest flaws, such as particle boundaries; that is, the raw material must be a monocrystal. The quality of a crystal is limited in practice, however, not only by such large-angle particle boundaries but also by many often small defects, which despite their small size three-dimensionally cause major local variations in the optical properties through the volume of the raw material.

The local defects that occur in the aforementioned monocrystals are inclusions, bubbles, veiling, crystallographic offsets, sliding planes, or sliding bands (face defects) and small-angle particle boundaries with slight differences in orientation (less than 10°). Contaminants often become deposited at small-angle particle boundaries, such as CaO deposits in the case of CaF, which can lead to local discontinuities in the index of refraction.

At present, the assessment of the internal optical quality characteristics in both glasses and crystals is done by a tester. The classification of the optical raw material or blank thus depends on the experience and skills of the particular tester and is no way uniform.

Monocrystals are produced in crystal growing systems. The geometric shape and size of the crystal is determined largely by the growth apparatus. The crystals must therefore be put in the desired starting shape afterward by means of sawing and the like. The situation is similar for technical glasses, which are often melted in large crucibles and then cut to the right size. Producing such large-volume (that is, with a diameter >25 cm and in particular ≧30 cm) bodies of material (glass block, raw crystals, etc.) as the starting material for optical elements that are supposed to be as free as possible of optical discontinuities, however, is quite expensive.

In producing an optical element, the goal is typically to cut it apart from the large-volume material body of the blank in such a way that its volume is as homogeneous as possible, and discontinuities that might be present in the material body, such as veiling, small-angle particle boundaries, and so forth, are located outside the cutting lines. In order to assure this, until now, the cutting was done with a fairly generous margin around such discontinuities, and the attempt was then made to produce optical elements of the desired size from the remaining material. It was therefore not possible until now to make optimal utilization, in a targeted way, of the more or less “clean” part of such a material body.

Given the large size of raw material pieces to be cut apart mechanically into individual pieces, optimizing of the cut in terms of dividing up the starting material on the basis of quality criteria was previously only theoretically possible, and the result is greatly dependent on the experience and diligence of the person doing the testing. In characterizing the raw materials, small-volume defects, because of their poor detectability, have until now played only a subordinate role, while the quality determination is done predominantly on the basis of extensive discontinuities that are easier to detect.

The object of the invention is therefore to create a method for quality control and cut optimization of optical raw materials by detecting and classifying quality characteristics in optical raw materials.

This object is attained according to the invention by the method defined by claim 1. Advantageous features of the method are described in the various dependent claims.

With the method of the invention, it is possible, in the three-dimensional shape of the body or blank, to create a three-dimensional copy of the defects or discontinuities found in the body examined. The optical elements can then be arranged in this three-dimensional overall image of the body, making the best possible utilization of the remaining defect-free space in the body, optionally with the aid of an iteration method known per se. This is especially advantageous particularly in extraordinarily expensive raw materials, such as large-volume monocrystals, because they make it possible to make an allocation as a function of the crystal orientation.

The determination of the three-dimensional shape defined by the outer surface of the body is known per se and can be done for instance by scanning or by triangulation of the optical coherence tomography, for instance using spectral radar. Such methods are often used for measuring objects such as historical buildings or art objects, but also in determining prostheses, in particular joint prostheses. By means of a calibrated optical 3D sensor, the surface of a body is scanned. From the values obtained, it is then possible after calibration, for instance by “reverse engineering”, to reconstruct the surface and model the object using data processing.

In a further step, the optical properties of the object, in particular the three-dimensional position of the various defects or discontinuities in the interior of the object, are then determined in single-layer or body planes. This can be done for instance by focusing using different focal lengths, or in layers. The optical properties are typically detected by means of a detector, such as a punctate, linear or area-type electronic detector. A CCD camera is a preferred detector. Another possibility is the technique of computed tomography, for instance, which is known from the field of medicine.

For determining block boundaries, the body is placed between polarization filters, and the changes in polarization are determined in a manner known per se. This operation is then repeated from more than one side, or with different directions of light transmission. In this way, a three-dimensional representation of all the block boundary faces and other contaminants occurring in the crystal is obtained.

In principle, it is possible to determine discontinuities both on the back side of the beam source, that is, with the beam passing through, and on the irradiated side, that is, with the reflected beam. It is furthermore possible to detect the beam scattered laterally by the disruptions in the body.

If such methods are performed from at least three observation directions, then the precise location of the individual discontinuities can be determined precisely, by means of optical triangulation. Typically, from four to eight observation directions are used for the determination, and in individual cases up to as many as twenty-five individual observations may be possible.

The method of the invention is suitable for all optical raw materials, such as glasses, crystals and plastics; oriented monocrystals, optical glass, and quartz glass are preferred. Among monocrystal materials, CaF₂, BaF₂, MgF₂, SrF₂, NaF, KF and CsF are especially preferred.

In a further preferred method according to the invention, the surface of the body to be examined, in order to increase the input and output of scanning beams, that is, to reduce reflection from the surface upon input and/or output, are provided with a coupling aid. A preferred coupling aid, for example, is immersion oil, of the kind known from microscopy.

In another preferred embodiment, a fit component which is adapted for positive engagement with the body surface in the direction to be observed is placed against the object to be examined. On the side toward the scanning radiation, this fit component is flat, so that the electromagnetic wave can enter as perpendicularly as possible. In this way, artifacts of the kind that occur for instance if the radiation enters the body surface at various angles and is then differently diffracted, can be avoided, since here the wave in general enters the fit component perpendicular to the surface and from there moves into the body. Here again, it is preferred for a coupling aid such as immersion oil to be disposed between the fit component and the object. These aids preferably have a refraction similar to that of the material to be examined. As a result, the effort and expense for optical machining of the surface of the test specimen can be kept low.

In the method of the invention, scanning radiation is preferably used, which is capable of penetrating the object material to be examined with as little absorption as possible. An exception is naturally radiation, optionally including a sound wave, that is used to detect the surface or the three-dimensional shape of the object. A preferred scanning radiation is in particular light in the visible spectral range, and in particular coherent light, such as laser light, monochromatic or polychromatic light, and/or polarized light.

According to the invention, the quality characteristics of an optical volume are determined preferably with the aid of the tomography technique, known above all from medicine, in which the body or its volume is cut apart into two- or three-dimensional sectional or fragmentary images made up of pixels. The pixels of these sectional or fragmentary images are then analyzed and classified by computer-controlled image processing in terms of quality characteristics, and the defects found are detected and assessed in terms of their three-dimensional location, their size, and their intensity.

For cut optimization, the volume of the raw material volume is divided up, preferably under computer control, by comparing desired characteristics with the actual quality characteristics found in the raw material, taking such peripheral parameters as the required cutting allowances into account, and optimizing the cutting course with minimal cutting losses. This kind of division is possible for instance by means of iteration methods known per se.

The embodiment according to the invention thus makes it possible to determine and assess all the quality characteristics of an optical volume completely, with the goal being to optimize the use of material for various vendor products. The invention can be employed especially advantageously for completely, automatically cutting apart and allocating bodies that tend to have major local variations in optical properties within their volume.

A particular advantage of the invention is that considerable better utilization of scarce, expensive materials, such as a CaF, can be achieved by minimizing the cutting losses and increasing the yield. If desired, the method can be designed to be interactive, in order to help workers carry out the optimized allocation.

The term tomography means the creation of as a rule two-dimensional slice images of a body to be examined, using many different projections of a scanning radiation which is picked up by detectors after passing through the body. The signals from the detectors are then processed in such a way as to produce the desired image. Processing the signals is complicated and can be done only with powerful computers, which is why the term computed tomography, abbreviated CT, is also used. Similar image processing is done in generating images using nuclear magnetic resonance or electron spin resonance (NMR and ESR). The image processing techniques are widely known, especially from the field of medicine.

With this technique, it is in principle also possible to show fragments of the test body three-dimensionally, which can then be compared with and adapted to an optical element to be produced, or in the case where there are many different optical elements, the particular one that best utilizes the defect-free space can be selected.

As the scanning radiation, electromagnetic waves, such as light beams, x-rays, and gamma rays; particle radiation, such as electron or positron radiation; or acoustic waves, such as ultrasonic beams, can be used. This type of scanning radiation is projected in from outside, modified (diffracted, weakened, scattered, etc.) in the interior of the body being examined, and after emerging from the body detected by detectors. The detected scanning radiation can also be generated in the interior of the body itself, for instance by means of fluorescence, or by resonance effects as in the case of ESR and NMR, in which case the type and extent of what is created allow one to draw conclusions about the nature of the interior of the body.

The selection of the scanning radiation is made on the basis of the properties of the body to be examined, that is, taking into account the interaction of the scanning radiation with the body or with the defects in the body that are to be detected. The prerequisite as a rule is naturally that the scanning radiation not change the body to be tested. Finally, in the course of the quality control, the examination should ascertain the properties that are important for the later use of the body (nondestructive testing).

In light-permeable crystals such as CaF, it must for instance be noted that radiation of high intensity or high quantum energy can permanently change the transmission properties.

The scanning radiation should also be capable of being input into the body to be tested at relatively little effort or expense. Thus with optical bodies, before they are measured, polishing is usual, but the expense for this should not exceed the usual amount.

For ascertaining the properties of crystals, the following measuring methods can be employed:

Particle boundaries, inclusions and veiling, like fluorescence, can be detected with light, preferably laser light, of a suitable wavelength or wavelengths, by transmitted light or scattered light. All the measuring techniques required for qualifying the raw material are used.

The crystallographic orientation is typically ascertained by X-ray, preferably at a split place. In principle, it is naturally also possible to determine the orientation directly from the crystal.

The stress-induced double refraction is preferably rendered visible with polarized light (in the polariscope).

For assessing the quality of the body to be tested, it is also possible, and as a rule this is also done, to combine a plurality of measuring methods and to superimpose the tomography images obtained for the individual measuring methods on one another in a suitable way, for instance in different colors, in order to make all the relevant defects in the tested body visible in a single image.

From such an image of defects, the entire volume of the body to be tested can then be cut apart into individual pieces in accordance with the predetermined criteria.

For producing a tomographic copy of a desired region in the body to be tested, the procedure is preferably as follows:

First, by means of an optical device, the outer contour or in other words the three-dimensional shape of the test specimen to be measured, such as a CaF monocrystal, is detected geometrically and established as a coordinate system.

Then, with suitable coupling aids, the surface of the test specimen is made sufficiently transparent for the inputting and outputting of the scanning radiation. As noted, light beams, x-rays, or sound waves can be used as the scanning radiation. For light or laser beams, for example, an optimally unpolished surface can be coated with immersion oil to create optical access for inspecting the interior of the test specimen. Polishing the surface for this purpose is also possible.

With the scanning radiation (such as a laser beam) and a scanner, the interior of the test specimen is scanned completely. The radiation that emerges again or is reflected, having been interfered with (attenuated) or diverted (scattered) at quality defects, is detected by a detector unit, and the signals acquired at the detector unit are then analyzed and classified in terms of predetermined characteristics, by means of image processing in the usual known way.

The structures thus found are then detected in terms of their three-dimensional position, their size, and their intensity, and are embedded in the coordinate system of the test specimen. The structures found can include not only defective structures, such as particle boundaries, sliding bands, bubbles, inclusions, and so forth, but also the crystal orientation.

Finally, the data obtained are entered in a data base for further use.

The sequence of the optimized allocation of material for a current vendor requirement is then as follows:

1. Setting up a target function with the criteria for performing the optimization.

2. Under computer control, breaking down the orders on hand in terms of geometries, quality characteristics, and delivery dates.

3. Storing the characteristic variables pertaining to quality in an environment (data base) that can be evaluated by data technology.

4. Under computer control (or interactively with computer support), allocating the material by comparing the characteristics of the order with the quality characteristics found in the raw material, taking such peripheral parameters as the required cutting allowances into account.

5. Computer-controlled optimization of the cutting course for optimal usage of material with minimal cutting losses.

6. Specification of the cutting course to the cutting technique (such as sawing, splitting, breaking, etc.).

The allocation is done on the basis of customer specifications, available quality, deliverability, the allocation or qualification technique, and vendor preferences.

With the method of the invention, it is also possible to produce lenses, prisms, rigid optical fiber rods, optical windows, and optical devices for DUV lithography. The method is therefore especially applicable for producing steppers and excimer lasers and thus also for producing integrated circuits as well as electronic devices, such as computers containing computer chips, and other electronic devices that contain chiplike integrated circuits.

1. A method for quality control of a body comprising an optical raw material and for optimizing its being cut apart into optical elements, in which optical discontinuities in the body are detected and the optical elements are cut from body parts that have as few discontinuities as possible or are essentially free of discontinuities, characterized in that the three-dimensional shape of the body is detected by means of three-dimensional geometry recognition in a coordinate system; and that
the optical properties of the body are detected, in body planes located above the other and formed of pixels, by means of scanning radiation; and that
from that, a three-dimensional image of the optical properties of the body is generated.

2. The method of claim 1, characterized in that the detection of the optical properties is done with a detector.

3. The method of one of the foregoing claims, characterized in that the object is irradiated with scanning radiation from the front side and/or back side, and the transmission, polarization, reflection and/or scattering of the radiation is detected.

4. The method of one of the foregoing claims, characterized in that the object is an oriented monocrystal, glass, or quartz glass.

5. The method of claim 4, characterized in that the orientation of the crystal is determined at a split place.

6. The method of one of claims 4 or 5, characterized in that before the detection of the three-dimensional shape, visible small-angle particle boundaries of the crystal are marked and are detected with that marking.

7. The method of one of the foregoing claims, characterized in that to improve the input and/or output of the scanning radiation, the surface of the body is treated with a coupling aid.

8. The method of claim 7, characterized in that the coupling aid is an immersion oil.

9. The method of one of the foregoing claims, characterized in that a fit component which has one side adapted for positive engagement with the body surface and one side opposite it is placed against the body surface and has a flat face that is perpendicular to the entering and/or exiting scanning radiation.

10. The method of one of the foregoing claims, characterized in that the slice images are created by computed tomography.

11. The method of one of the foregoing claims, characterized in that the slice images obtained are used for cut optimization in dividing the volume of raw material being examined into individual pieces, by comparison with desired characteristics.

12. The method of one of the foregoing claims, characterized in that electromagnetic waves and/or particle radiation and/or acoustic waves are used as the scanning radiation.

13. The method of one of the foregoing claims, characterized in that the scanning radiation is generated in the volume being examined itself.

14. The method of one of the foregoing claims, characterized in that a plurality of measuring methods are combined, and the variously obtained images are analyzed and superimposed with computer support.

15. The method of one of the foregoing claims, characterized in that with it, optical elements are produced.

16. The method of one of the foregoing claims, characterized in that it is used for producing lenses, prisms, optical windows, and optical components for DUV lithography, steppers, excimer lasers, wafers, computer chips, as well as integrated circuits and electronic devices.

17. An optical element that can be obtained by one of the methods of claims 1-16.

18. A method for quality control of a body comprising an optical raw material and for optimizing its being cut apart into optical elements, in which optical discontinuities in the body are detected and the optical elements are cut from body parts that have as few discontinuities as possible or are essentially free of discontinuities, characterized in that the three-dimensional shape of the body is detected by means of three-dimensional geometry recognition in a coordinate system; and that
the optical properties of the body are detected, in body planes located above the other and formed of pixels, by means of scanning radiation; and that
from that, a three-dimensional image of the optical properties of the body is generated.

19. The method of claim 18, characterized in that the detection of the optical properties is done with a detector.

20. The method of claim 18, characterized in that the object is irradiated with scanning radiation from the front side and/or back side, and the transmission, polarization, reflection and/or scattering of the radiation is detected.

21. The method of claim 18, characterized in that the object is an oriented monocrystal, glass, or quartz glass.

22. The method of claim 21, characterized in that the orientation of the crystal is determined at a split place.

23. The method of claim 21, characterized in that before the detection of the three-dimensional shape, visible small-angle particle boundaries of the crystal are marked and are detected with that marking.

24. The method of claim 18, characterized in that to improve the input and/or output of the scanning radiation, the surface of the body is treated with a coupling aid.

25. The method of claim 24, characterized in that the coupling aid is an immersion oil.

26. The method of claim 18, characterized in that a fit component which has one side adapted for positive engagement with the body surface and one side opposite it is placed against the body surface and has a flat face that is perpendicular to the entering and/or exiting scanning radiation.

27. The method of claim 18, characterized in that the slice images are created by computed tomography.

28. The method of claim 18, characterized in that the slice images obtained are used for cut optimization in dividing the volume of raw material being examined into individual pieces, by comparison with desired characteristics.

29. The method of claim 18, characterized in that electromagnetic waves and/or particle radiation and/or acoustic waves are used as the scanning radiation.

30. The method of claim 18, characterized in that the scanning radiation is generated in the volume being examined itself.

31. The method of claim 18, characterized in that a plurality of measuring methods are combined, and the variously obtained images are analyzed and superimposed with computer support.

32. The method of claim 18, characterized in that with it, optical elements are produced.

33. The method of claim 18, characterized in that it is used for producing lenses, prisms, optical windows, and optical components for DUV lithography, steppers, excimer lasers, wafers, computer chips, as well as integrated circuits and electronic devices.

34. An optical element that can be obtained by a method of claim 18.
